(19) United States
(12) Patent Application Publication
(10) Pub. No.: US 2019/0159286 A1
(43) Pub. Date: May 23, 2019

(54) Data Relaying in a Wireless Communications Network

(71) Applicant: Telefonaktiebolaget LM Ericsson (publ), Stockholm (SE)

(72) Inventors: Thomas Nilsson, Malmö (SE); Dzevdan Kapetanovic, Lund (SE)

(21) Appl. No.: 16/314,762

(22) PCT Filed: Jul. 12, 2016
(86) PCT No.: PCT/EP2016/066475

§ 371 Date: Jan. 2, 2019

(51) Int. Cl. H04W 88/04; H04W 72/04; H04W 48/08

(52) U.S. Cl. CPC H04W 88/04; H04W 48/08; H04W 72/0406

(57) ABSTRACT

There is provided mechanisms for data relaying in a wireless communications network. A method is performed by a network node. The method comprises transmitting a trigger message for a second wireless device to transmit uplink data in a timeslot. The method comprises transmitting downlink data to a first wireless device in the timeslot.

### TECHNICAL FIELD

Embodiments presented herein relate to a method, a network node, wireless devices, computer programs, and a computer program product for data relaying in a wireless communications network.

### BACKGROUND

In communications networks, there may be a challenge to obtain good performance and capacity for a given communications protocol, its parameters and the physical environment in which the communications network is deployed.

For example, existing communications networks that today predominantly support very high data rates may not be well suited for communications relating to applications for IoT (Internet of Things) communications, energy management, sensor applications, etc. For this reason communications networks are developed that are optimized to support communication at longer ranges and lower data rates (preferably using less power consumption) than traditional communications networks.

As an example, according to IEEE 802.11ax (where IEEE is short for Institute of Electrical and Electronics Engineers) a tone plan has been set for a new Fast Fourier Transform (FFT) size of 256 (4 times compared to its legacy size). The smallest allocated sub-band, called a resource unit, consists of 26 subcarriers. Each resource unit contains two pilot tones. The largest tone unit for 20 MHz contains 106 tones and 4 pilot tones. There are other tone unit sizes for different bandwidths. This tone plan is required for resource allocation with Orthogonal Frequency-Division Multiple Access (OFDMA) in uplink (i.e. from served wireless device to serving network node) and downlink (i.e. from serving network node to served wireless device).

IEEE 802.11ax is expected to be asymmetric in uplink and downlink. A network node supporting IEEE 802.11ax could have more antennas and a higher output power than a served wireless device. Further, to minimize the power consumption, the wireless device could be required to use a lower output power and a modulation scheme with a low peak to average power ratio compared to the network node. However, a lower output power will reduce the communications range for the wireless device in the uplink. Some of this loss in communications range can be compensated by employing diversity techniques at the network node.

However, it could still be difficult for the wireless device to communicate with the network node.

### SUMMARY

An object of embodiments herein is to provide efficient communications between the wireless device and the network node, particularly for efficient uplink communications at long communications ranges.

According to a first aspect there is presented a method for data relaying in a wireless communications network. The method is performed by a network node. The method comprises transmitting a trigger message for a second wireless device to transmit uplink data in a timeslot. The method comprises transmitting downlink data to a first wireless device in the timeslot.

According to a second aspect there is presented a network node for data relaying in a wireless communications network. The network node comprises processing circuitry. The processing circuitry is configured to cause the network node to transmit a trigger message for a second wireless device to transmit uplink data in a timeslot. The processing circuitry is configured to cause the network node to transmit downlink data to a first wireless device in the timeslot.

According to a third aspect there is presented a network node for data relaying in a wireless communications network. The network node comprises processing circuitry and a computer program product. The computer program product stores instructions that, when executed by the processing circuitry, causes the network node to perform operations, or steps. The operations, or steps, cause the network node to transmit a trigger message for a second wireless device to transmit uplink data in a timeslot. The operations, or steps, cause the network node to transmit downlink data to a first wireless device in the timeslot.

According to a fourth aspect there is presented a network node for data relaying in a wireless communications network. The network node comprises a transmit module configured to transmit a trigger message for a second wireless device to transmit uplink data in a timeslot. The network node comprises a transmit module configured to transmit downlink data to a first wireless device in the timeslot.

According to a fifth aspect there is presented a computer program for data relaying in the wireless communications network, the computer program comprising computer program code which, when run on processing circuitry of a network node, causes the network node to perform a method according to the first aspect.

According to a sixth aspect there is presented a method for data relaying in a wireless communications network. The method is performed by a first wireless device. The method comprises receiving downlink data from a network node in a timeslot. The method comprises receiving uplink data from a second wireless device in the timeslot. The method comprises transmitting the received uplink data to the network node as part of an uplink transmission.

According to a seventh aspect there is presented a wireless device for data relaying in a wireless communications network. The wireless device comprises processing circuitry. The processing circuitry is configured to cause the wireless device to receive downlink data from a network node in a timeslot. The processing circuitry is configured to cause the wireless device to receive uplink data from another wireless device in the timeslot. The processing circuitry is configured to cause the wireless device to transmit the received uplink data to the network node as part of an uplink transmission.

According to an eighth aspect there is presented a wireless device for data relaying in a wireless communications network. The wireless device comprises processing circuitry and a computer program product. The computer program product stores instructions that, when executed by the processing circuitry, causes the wireless device to perform operations, or steps. The operations, or steps, cause the wireless device to receive downlink data from a network node in a timeslot. The operations, or steps, cause the wireless device to receive uplink data from another wireless device in the timeslot. The operations, or steps, cause the wireless device to transmit the received uplink data to the network node as part of an uplink transmission.

According to a ninth aspect there is presented a wireless device for data relaying in a wireless communications network. The wireless device comprises a receive module configured to receive downlink data from a network node in a timeslot. The wireless device comprises a receive module configured to receive uplink data from another wireless device in the timeslot. The wireless device comprises a transmit module configured to transmit the received uplink data to the network node as part of an uplink transmission.

According to a tenth aspect there is presented a computer program for data relaying in the wireless communications network, the computer program comprising computer program code which, when run on processing circuitry of a wireless device acting as a first wireless device, causes the wireless device to perform a method according to the sixth aspect.

According to an eleventh aspect there is presented a method for data relaying in a wireless communications network. The method is performed by a second wireless device. The method comprises receiving, from a network node, a trigger for transmitting uplink data in a timeslot. The method comprises transmitting the uplink data in the timeslot to a first wireless device.

According to a twelfth aspect there is presented a wireless device for data relaying in a wireless communications network. The wireless device comprises processing circuitry. The processing circuitry is configured to cause the wireless device to receive, from a network node, a trigger for transmitting uplink data in a timeslot. The processing circuitry is configured to cause the wireless device to transmit the uplink data in the timeslot to another wireless device.

According to an thirteenth aspect there is presented a wireless device for data relaying in a wireless communications network. The wireless device comprises processing circuitry and a computer program product. The computer program product stores instructions that, when executed by the processing circuitry, causes the wireless device to perform operations, or steps. The operations, or steps, cause the wireless device to receive, from a network node, a trigger for transmitting uplink data in a timeslot. The operations, or steps, cause the wireless device to transmit the uplink data in the timeslot to another wireless device.

According to a fourteenth aspect there is presented a wireless device for data relaying in a wireless communications network. The wireless device comprises a receive module configured to receive, from a network node, a trigger for transmitting uplink data in a timeslot. The wireless device comprises a transmit module configured to transmit the uplink data in the timeslot to another wireless device.

According to a fifteenth aspect there is presented a computer program for data relaying in the wireless communications network, the computer program comprising computer program code which, when run on processing circuitry of a wireless device acting as a second wireless device, causes the wireless device to perform a method according to the eleventh aspect.

According to a sixteenth aspect there is presented a computer program product comprising a computer program according to at least one of the fifth aspect, the tenth aspect, and the fifteenth aspect and a computer readable storage medium on which the computer program is stored. The computer readable storage medium can be a non-transitory computer readable storage medium.

Advantageously these methods, these network nodes, these wireless devices acting as the first wireless device, these wireless devices acting as the second wireless device, and these computer programs provide efficient communications between the wireless device acting as the second wireless device and the network node, particularly in the uplink from the wireless device acting as the second wireless device to the network node and at long communications ranges.

Advantageously these methods, these network nodes, these wireless devices acting as the first wireless device, these wireless devices acting as the second wireless device, and these computer programs improve the communications range for the wireless device acting as the second wireless device in the uplink and at the same time lowers the energy consumption of the wireless device acting as the second wireless device.

It is to be noted that any feature of the first, second, third, fourth, fifth, sixth seventh, eight, ninth, tenth, eleventh, twelfth, thirteen, fourteenth, fifteenth and sixteenth aspects may be applied to any other aspect, wherever appropriate. Likewise, any advantage of the first aspect may equally apply to the second, third, fourth, fifth, sixth, seventh, eight, ninth, tenth, eleventh twelfth, thirteen, fourteenth, fifteenth and sixteenth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, 4, 5, and 6 are flowcharts of methods according to embodiments; and

FIGS. 7 and 8 are schematic illustrations of time-frequency resources according to embodiments;

FIG. 9 is a schematic diagram showing functional units of a network node according to an embodiment;

FIG. 10 is a schematic diagram showing functional modules of a network node according to an embodiment;

FIG. 11 is a schematic diagram showing functional units of a wireless device according to an embodiment;

FIG. 12 is a schematic diagram showing functional modules of a wireless device according to an embodiment; and

FIG. 13 is a schematic diagram showing functional units of a wireless device according to an embodiment;

FIG. 14 is a schematic diagram showing functional modules of a wireless device according to an embodiment; and

FIG. 15 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

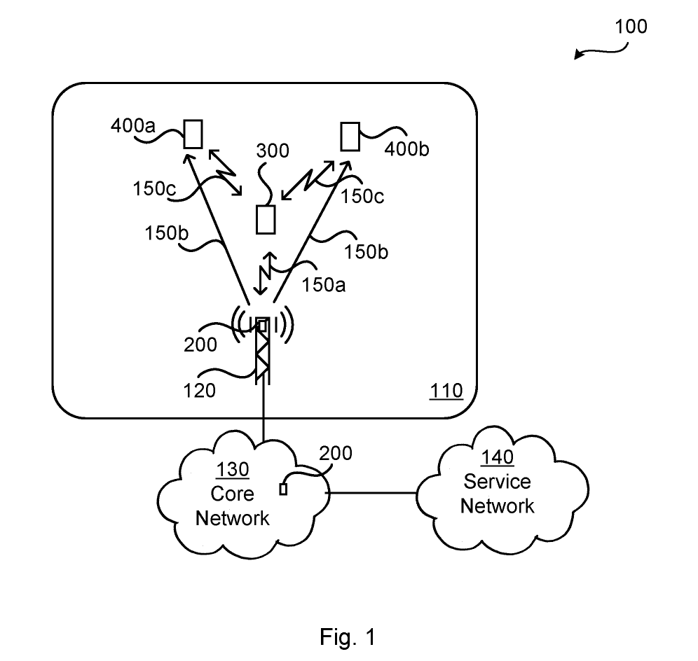

FIG. 1 is a schematic diagram illustrating a wireless communications network 100 where embodiments presented herein can be applied.

The wireless communications network 100 comprises a radio access network 110, a core network 130 and a service network 140. The radio access network 110 comprises at least one radio access network node 120. The radio access network node 120 could be a radio base station, base transceiver station, node B, evolved node B, access point (AP), or access node.

The wireless communications network 100 further comprises at least one network node 200 (NN). The functionality of the network node 200 could be provided in the radio access network 110, such as in the radio access network node 120, or in the core network 130. A detailed description of the network node 200 and its functionality will be disclosed below.

A wireless device (WD) 300, 400a, 400b operatively connected to the radio access network 110 is enabled to exchange data with, and access services provided by, the service network 140. The wireless device 300, 400a, 400b could be a portable wireless device, mobile station, mobile phone, handset, wireless local loop phone, user equipment (UE), smartphone, laptop computer, tablet computer, station (STA), IoT device, network equipped sensor, etc.

The wireless device 300 will hereinafter be denoted first wireless device 300 and the wireless device 400a, 400b will hereinafter be denoted second wireless device 400a, 400b. The wireless device 300 is assumed to be able to communicate with the radio access network 110 in both uplink and downlink (as indicated by double-directional arrow 150a) whereas the wireless device 400a, 400b is assumed to be able to communicate with the radio access network 110 only in downlink (as indicated by single-directional arrow 150b). For example, the second wireless device 400a, 400b could have lower transmit power usage than the first wireless device 300. Further, the wireless device 300 and the wireless device 400a, 400b are assumed to be able to communicate with each other (as indicated by double-directional arrow 150c).

According to some aspects the wireless communications network 100 is an IEEE 802.11ax wireless local area network. The communications network 100 could be based on Multiple input, multiple output-orthogonal frequency division multiplexing (MIMO-OFDM) transmission. Downlink data transmitted from the network node 200 could thus be transmitted using OFDMA or multi-user (MU) MIMO. Further, uplink data transmitted from the first wireless device 300 and the second wireless device 400a, 400b could be transmitted using OFDMA or MU-MIMO.

In traditional IEEE 802.11 based communications networks, the uplink is not scheduled and all the wireless devices 300, 400a, 400b contend for access the communications channel (i.e., for transmitting data to the network node 200) using the Carrier Sense Multiple Access with Collision Avoidance (CSMA/CA) scheme. Collisions between transmissions from different wireless devices 300, 400a, 400b in the uplink to the radio access network node 120 will degrade the performance of the wireless communications network 100 and cause retransmissions and increased power consumption of the wireless devices 300, 400a, 400b.

In order to improve the performance of the wireless communications network 100, the wireless devices 300, 400a, 400b could be scheduled in the uplink. This could improve the reliability of the communications between the wireless devices 300, 400a, 400b and the radio access network node 120. A trigger message (as transmitted by the network node 200) can be used to control when in time the wireless devices 300, 400a, 400b are allowed to transmit in the uplink.

In order to further improve the performance of the wireless communications network 100, some of the wireless devices 300, 400a, 400b could act as relays for other ones of the wireless devices 300, 400a, 400b. Hereinafter it will be assumed that wireless device 300 can act as relay for wireless device 400a, 400b. As the skilled person understands, although the schematic illustration of FIG. 1 illustrates one wireless device 300 acting as a relay for two wireless devices 400a, 400b, the herein disclosed embodiments are not limited to any particular number of first wireless devices 300 or second wireless devices 400a, 400b or how many second wireless devices 400a, 400b having their uplink data relayed by the same first wireless device 300.

In general terms, traditional relaying involves receiving a packet from one device and transmitting the packet to another device. This approach can be used to relay packets from wireless device 400a, 400b in the uplink by wireless device 300 to the network node 200. This could be costly (in terms of network resources, power consumption, etc.) and there may therefore not be any incentives for wireless device 300 to explicitly relay data from wireless device 400a, 400b to the network node 200. However, if the act of relaying can be included in already existing (i.e., normal) communications between the network node 200 and wireless device 300 the costs for the thus relaying wireless device 300 can be kept low.

The herein disclosed embodiments are therefore based on scheduling downlink data to wireless device 300 that can act as relay at the same time as scheduling uplink data from wireless device 400a, 400b. Wireless device 300 will then simultaneously receive the downlink data from the network node 200 (hence, it will be rewarded for acting as a relay, by receiving some data) as well as the uplink data sent from the wireless device 400a, 400b. The uplink data from wireless device 400a, 400b will then be relayed to the network node 200 by the wireless device 300.

The embodiments disclosed herein thus relate to mechanisms for data relaying in the wireless communications network 100. In order to obtain such mechanisms there is provided a network node 200, a method performed by the network node 200, a computer program product comprising code, for example in the form of a computer program, that when run on processing circuitry of the network node 200, causes the network node 200 to perform the method. In order to obtain such mechanisms there is further provided a wireless device 300, a method performed by the wireless device 300, and a computer program product comprising code, for example in the form of a computer program, that when run on processing circuitry of the wireless device 300, causes the wireless device 300 to perform the method. In order to obtain such mechanisms there is further provided a wireless device 400a, 400b, a method performed by the wireless device 400a, 400b, and a computer program product comprising code, for example in the form of a computer program, that when run on processing circuitry of the wireless device 400a, 400b, causes the wireless device 400a, 400b to perform the method.

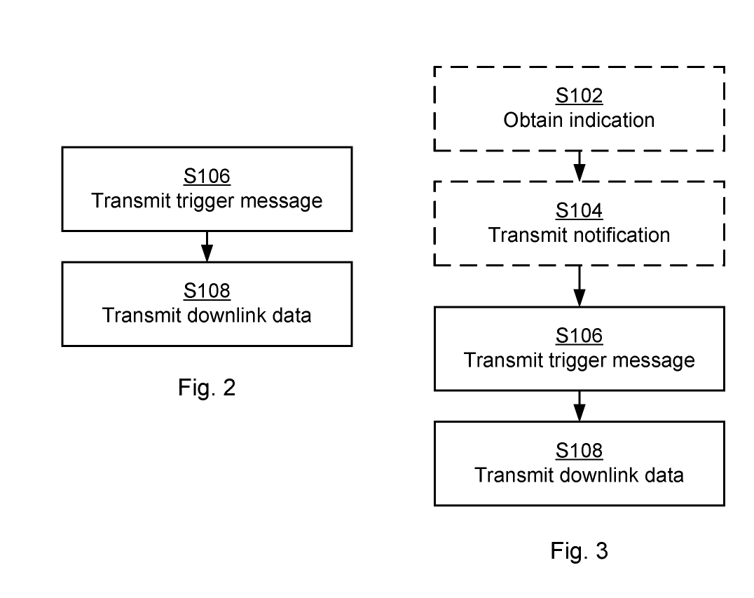

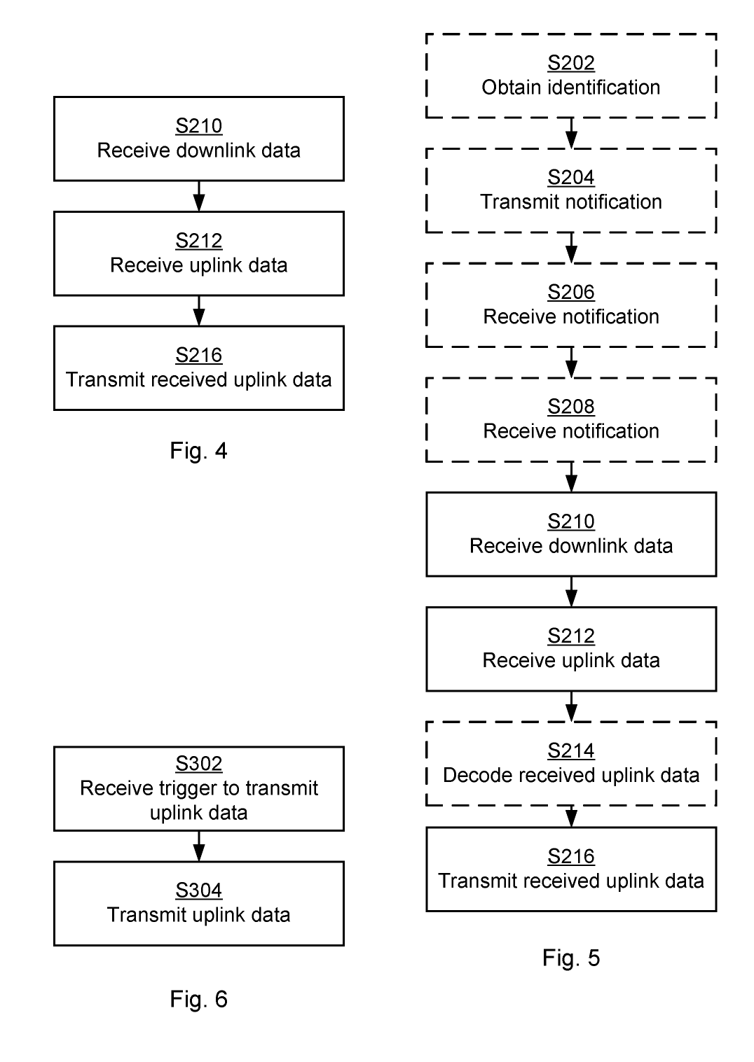

FIGS. 2 and 3 are flowcharts illustrating embodiments of methods for data relaying in a wireless communications network 100 as performed by the network node 200. FIGS. 4 and 5 are flowcharts illustrating embodiments of methods for data relaying in a wireless communications network 100 as performed by the wireless device 300. FIG. 6 is a flowchart illustrating an embodiment of a method for data relaying in a wireless communications network 100 as performed by the wireless device 400a, 400b. The methods are advantageously provided as computer programs.

Reference is now made to FIG. 2 illustrating a method for data relaying in a wireless communications network 100 as performed by the network node 200 according to an embodiment.

The network node 200 could select a set of second wireless devices 400a, 400b for uplink transmission and a set of first wireless devices 300 that can act as relays for downlink transmission. How to select these sets will be disclosed below. In particular, the network node 200 is configured to perform step S106:

S106: The network node 200 transmits a trigger message for the second wireless device 400a, 400b to transmit uplink data in a timeslot.

Further, the network node 200 is configured to perform step S108:

S108: The network node 200 transmits downlink data to the first wireless device 300 in the timeslot. The downlink data is transmitted after the trigger message and at the same time as the uplink data is transmitted from the second wireless device 400a, 400b, see below.

This enables uplink data from the second wireless device 400a, 400b to be relayed in the uplink, thereby enabling the communications range of the second wireless device 400a, 400b to be extended and its power consumption to be reduced.

Reference is now made to FIG. 3 illustrating methods for data relaying in a wireless communications network too as performed by the network node 200 according to further embodiments. It is assumed that steps S106, S108 are performed as described above with reference to FIG. 2 and a thus repeated description thereof is therefore omitted.

There may be different ways for the network node 200 to select the set of first wireless devices 300 that can act as relays for downlink transmission, and thus to for the network node 200 to determine which wireless device(s) could act as first wireless devices 300. According to some aspects the determination is based on an indication. Hence, according to an embodiment the network node 200 is configured to perform step S102:

S102: The network node 200 obtains an indication that the first wireless device 300 is configured to act as a relay for the second wireless device 400a, 400b.

There could be different ways for the network node 200 to obtain the indication in step S102. For example, the indication could be based on positioning data of the first wireless device 300 or a signal to noise ratio (SNR) of the first wireless device 300. Further, the indication could be received from the first wireless device 300 itself, it could be retrieved from a database storing such indications, or received from another network node 200.

There may be different ways for the network node 200 to select the set of second wireless devices 400a, 400b for uplink transmission and thus for the network node 200 to determine which wireless device(s) could act as second wireless devices 400a, 400b. According to some aspects the determination is based on similar mechanisms as which wireless device(s) could act as first wireless devices 300. Hence, the determination of which wireless device(s) could act as second wireless devices 400a, 400b can be based on positioning data of the second wireless device 400a, 400b or an SNR of the second wireless device 400a, 400b. Further, as disclosed below (in step S202) the network node 200 could obtain notification about the second wireless device 400a, 400b from the first wireless devices 300. Additionally or alternatively, the network node 200 could determine that relaying is performed for the second wireless device 400a, 400b upon detecting that the signal strength of signals received from the second wireless device 400a, 400b is weak (for example, due to small-scale or large-scale fading). The signal strength can be detected as being weak when having a signal strength value lower than a signal strength threshold value. Detecting that the signal strength of signals received from the second wireless device 400a, 400b is weak could trigger the network node 200 to perform step S106.

In some aspects the network node 200 informs the first wireless device 300 to forward the uplink data from the second wireless device 400a, 400b. This could prepare the first wireless device 300 to receive such uplink data when it arrives. Hence, according to an embodiment the network node 200 is configured to perform step S104:

S104: The network node 200 transmits a notification to the first wireless device 300 to forward uplink data received from the second wireless device 400a, 400b in the timeslot to the network node 200. Step S104 is performed before step S108.

Reference is now made to FIG. 4 illustrating a method for data relaying in a wireless communications network 100 as performed by the wireless device 300 according to an embodiment.

As disclosed above, the network node 200 in step S108 transmits downlink data to the wireless device 300. It is assumed that the wireless device 300 receives this data and hence is configured to perform step S210:

S210: The wireless device 300 receives downlink data from the network node 200 in a timeslot.

As further disclosed above, the network node 200 in step S106 transmits a trigger message for the second wireless device 400a, 400b to transmit uplink data in the same timeslot. It is assumed that such a trigger message and such uplink data is transmitted. Hence, the wireless device 300 is configured to perform step S212:

S212: The wireless device 300 receives uplink data from the second wireless device 400a, 400b in the timeslot.

The wireless device 300 acting as a relay will thus simultaneously receive data from the network node 200 in the downlink and data from the second wireless device 400a, 400b in the uplink. Upon having received the downlink data in step S210 and the uplink data in step S212 the wireless device 300 transmits the received uplink data to the network node 200. Hence, the wireless device 300 is configured to perform step S216:

S216: The wireless device 300 transmits the received uplink data to the network node 200 as part of an uplink transmission. Examples of how the received uplink data could be transmitted to the network node 200 will be disclosed next.

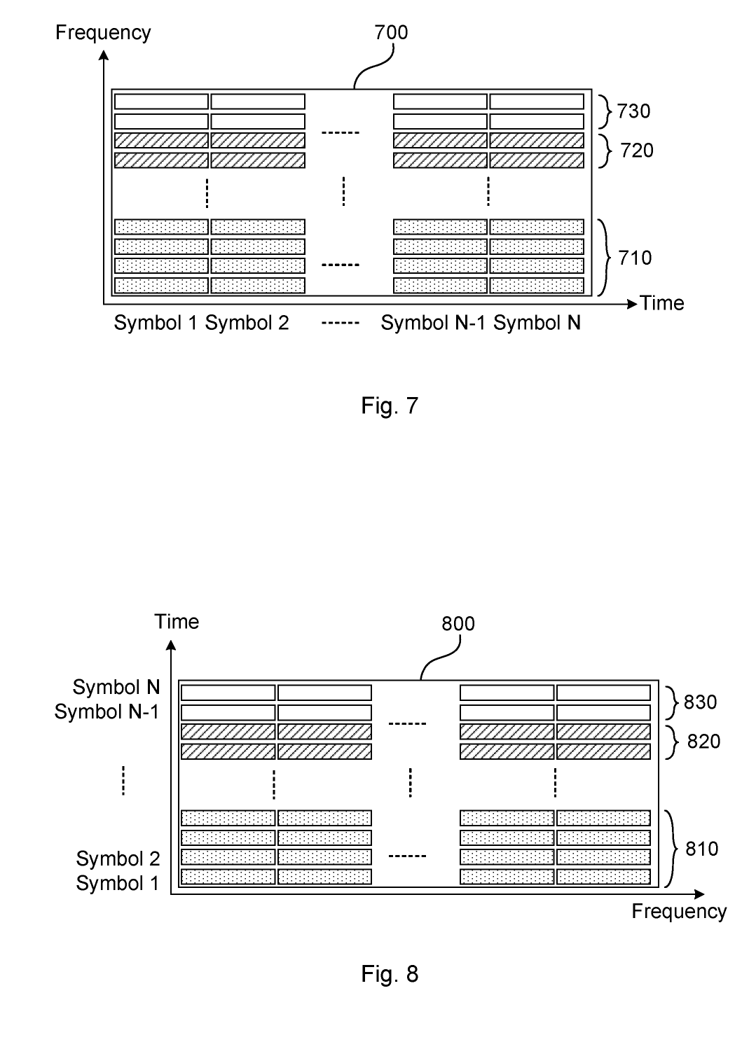

According to some aspects the received uplink data is transmitted in an acknowledgement (ACK) protocol message. Hence, according to a first embodiment the uplink transmission comprises an ACK protocol message of the downlink data to the network node 200. According to some aspects the received uplink data is transmitted as part of uplink data. Hence, according to a second embodiment the uplink transmission comprises uplink data of the wireless device 300 to the network node 200. That is, the received uplink data can be piggybacked to the ACK sent to the network node 200 following a downlink OFDMA/MU-MIMO transmission or be appended to the normal uplink data transmitted from the wireless device 300 to the network node 200, see FIGS. 7 and 8 below.

Reference is now made to FIG. 5 illustrating methods for data relaying in a wireless communications network 100 as performed by the wireless device 300 according to further embodiments. It is assumed that steps S210, S212, S216 are performed as described above with reference to FIG. 4 and a thus repeated description thereof is therefore omitted.

The wireless device 300 could thus identify second wireless devices 400a, 400b within its reception range and report these second wireless devices 400a, 400b to the network node 200. Hence, according to an embodiment the wireless device 300 is configured to perform steps S202, S204:

S202: The wireless device 300 obtains an identification of the second wireless device 400a, 400b from the second wireless device 400a, 400b. The indication could be based on positioning data of the second wireless device 400a, 400b or traffic data. Further, the identification may be received using a peer-to-peer or near-field communications mechanism with the second wireless device 400a, 400b.

S204: The wireless device 300 transmits a notification of the identification to the network node 200 prior to receiving the downlink data. The network node 200 can thereby be made aware of which second wireless device 400a, 400b could transmit uplink data to the wireless device 300.

In more detail, the wireless device 300 could attempt to decode packets transmitted by the second wireless device 400a, 400b and determine the corresponding signal to interference plus noise ratio (SINR). If the SINR is above a threshold value then an identity of the wireless device 400a, 400b could be recorded as a wireless device with a potential need of relaying. This information can be signaled by the wireless device 300 to the network node 200. If positioning is used then both the second wireless device 400a, 400b and the wireless device 300 could signal their positions to the network node 200, thereby enabling the network node 200 to determine the second wireless device 400a, 400b that are closest (in terms of signal strength, etc.) to each wireless device 300.

As disclosed above, the network node 200 in an embodiment transmits a notification (step S104) to the wireless device 300 to forward the uplink data received from the second wireless device 400a, 400b to the network node 200. There are different ways in which the wireless device 300 could be made aware that it is about to receive uplink data from the second wireless device 400a, 400b. In some aspects the network node 200 notifies the wireless device 300 of the identity of the second wireless device 400a, 400b. Hence, according to an embodiment the wireless device 300 is configured to perform step S206:

S206: The wireless device 300 receives a notification from the network node 200 before receiving the downlink data from the network node 200. The notification instructs the wireless device 300 to forward uplink data received from the second wireless device 400a, 400b in the timeslot to the network node 200. This could make the wireless device 300 aware that it is about to receive uplink data from the second wireless device 400a, 400b.

Further, as disclosed above, the network node 200 in an embodiment transmits a notification (step S104) to the wireless device 300 to receive the uplink data from the second wireless device 400a, 400b. Hence, according to an embodiment the wireless device 300 is configured to perform step S208:

S208: The wireless device 300 receives a notification from the network node 200 to receive the uplink data from the second wireless device 400a, 400b in the timeslot. This could make the wireless device 300 aware that it is about to receive uplink data from the second wireless device 400a, 400b. The notification in step S208 could be received before receiving the downlink data from the network node 200. Further, the wireless device 300 could receive a message from the network node 200 with a list of wireless devices 300 that will act as relays. If the wireless device 300 finds itself in the list of relays, the wireless device 300 could prepare to receive downlink data from the network node 200 as well as uplink data from the second wireless device 400a, 400b immediately following a short interframe space (SIFS) time duration.

There may be different ways for the wireless device 300 to process the uplink data before it is forwarded to the network node 200. Different embodiments relating thereto will now be described in turn. According to some aspects the wireless device 300 decodes the uplink data before forwarding it (thus performing so-called decode-and-forward). Hence, according to an embodiment the wireless device 300 is configured to perform step S214:

S214: The wireless device 300 decodes the received uplink data before forwarding the received uplink data. Step S214 is performed before step S216.

The wireless device 300 could thus decode the data for the second wireless device 400a, 400b (as well as its own received downlink data). In other aspects the wireless device 300 could amplify the uplink data before forwarding it (thus performing so-called amply-and-forward) and/or compress the uplink data before forwarding it (thus performing so-called compress-and-forward).

Reference is now made to FIG. 6 illustrating a method for data relaying in a wireless communications network 100 as performed by the wireless device 400a, 400b according to an embodiment.

As disclosed above, the network node 200 in step S106 transmits a trigger message to the wireless device 400a, 400b. It is assumed that the wireless device 400a, 400b receives this trigger message and hence is configured to perform step S302:

S302: The wireless device 400a, 400b receives, from the network node 200, a trigger for transmitting uplink data in a timeslot.

Once the trigger message is received, the wireless device 400a, 400b will determine if it is scheduled for uplink transmission. In response to having received the trigger in step S302 the wireless device 400a, 400b thus transmits uplink data (assuming that the wireless device 400a, 400b has uplink data to transmit).

S304: The wireless device 400a, 400b transmits the uplink data in the timeslot to the first wireless device 300. Hence, the uplink data is not transmitted directly to the network node 200 but to the first wireless device 300 thus acting as a relay.

The wireless device 400a, 400b thus performs step S304 when it has data to transmit. If this is the case the wireless device 400a, 400b could transmit the uplink data immediately following a SIFS time duration.

As disclosed above, the uplink data received by wireless device 300 can be appended to the normal uplink data transmitted by the wireless device 300 to the network node 200. FIGS. 7 and 8 are schematic illustrations of one block 700, 800 of uplink time-frequency resources for wireless device 300 according to embodiments. The blocks 700, 800 of time-frequency resources occupy resources corresponding to N symbols in time. According to the embodiment of FIG. 7, during each such symbol the wireless device 300 transmits one sub-block of its own uplink data 710, one sub-block of relayed uplink data 720 received from wireless device 400a, and one sub-block of relayed uplink data 730 received from wireless device 400b. According to the embodiment of FIG. 8, during each such symbol the wireless device 300 transmits sub-blocks of uplink data either being its own uplink data 810, or relayed uplink data 820 received from wireless device 400a, or relayed uplink data 830 received from wireless device 400a.

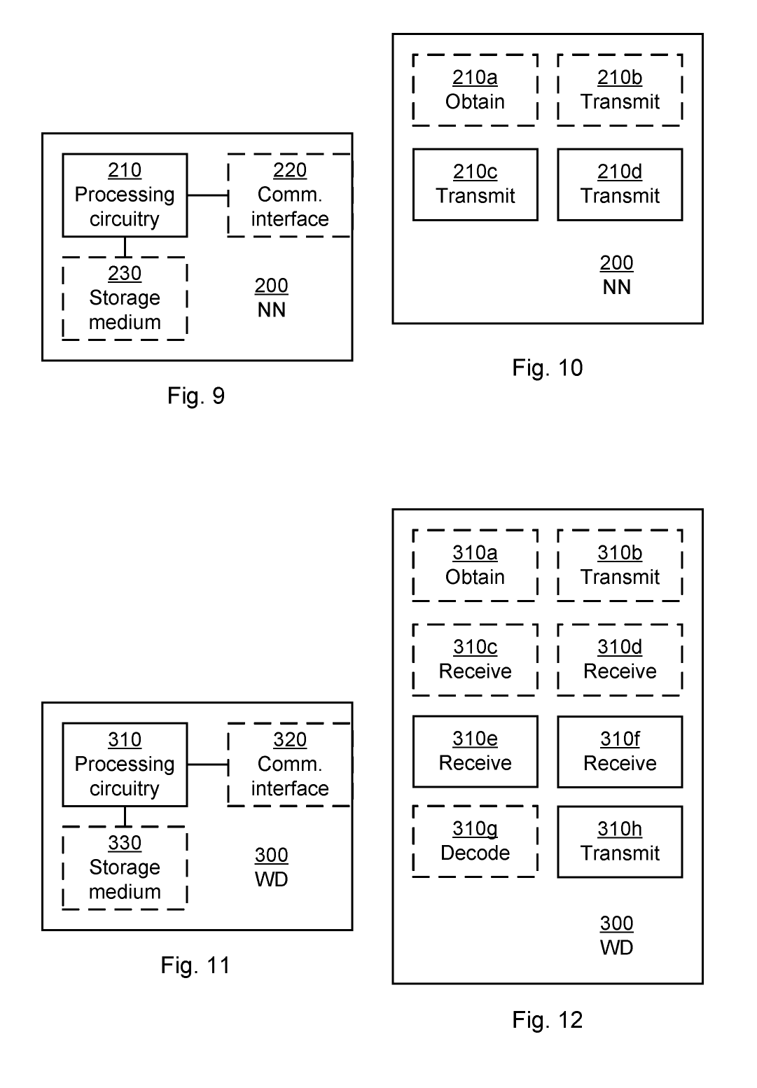

FIG. 9 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1510a (as in FIG. 15), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, S102-S108, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications interface 220 for communications at least with wireless devices 300, 400a, 400b and entities, nodes, and devices in the radio access network 110 and the core network 130. As such the communications interface 220 may comprise one or more transmitters and receivers, comprising analogue and digital components and a suitable number of antennas for wireless communications and ports for wireline communications.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 10 schematically illustrates, in terms of a number of functional modules, the components of a network node 200 according to an embodiment. The network node 200 of FIG. 10 comprises a number of functional modules; a transmit module 210c configured to perform step S106, and a transmit module configured to perform step S108. The network node 200 of FIG. 10 may further comprise a number of optional functional modules, such as any of an obtain module 210a configured to perform step S102 and a transmit module 210b configured to perform step S104. In general terms, each functional module 210a-210d may be implemented in hardware or in software. Preferably, one or more or all functional modules 210a-210d may be implemented by the processing circuitry 210, possibly in cooperation with functional units 220 and/or 230. The processing circuitry 210 may thus be arranged to from the storage medium 230 fetch instructions as provided by a functional module 210a-210d and to execute these instructions, thereby performing any steps of the network node 200 as disclosed herein.

The network node 200 may be provided as a standalone device or as a part of at least one further device. For example, the network node 200 may be provided in a node of the radio access network 110 or in a node of the core network 130. Alternatively, functionality of the network node 200 may be distributed between at least two devices, or nodes. These at least two nodes, or devices, may either be part of the same network part (such as the radio access network 110 or the core network 130) or may be spread between at least two such network parts. In general terms, instructions that are required to be performed in real time may be performed in a device, or node, in the radio access network 110 than instructions that are not required to be performed in real time.

Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 9 the processing circuitry 210 may be distributed among a plurality of devices, or nodes. The same applies to the functional modules 210a-210d of FIG. 10 and the computer program 1510a of FIG. 4 (see below).

FIG. 11 schematically illustrates, in terms of a number of functional units, the components of a wireless device 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1510b (as in FIG. 15), e.g. in the form of a storage medium 330. The processing circuitry 310 may further be provided as at least one application specific integrated circuit (ASIC), or field programmable gate array (FPGA).

Particularly, the processing circuitry 310 is configured to cause the wireless device 300 to perform a set of operations, or steps, S202-S216, as disclosed above. For example, the storage medium 330 may store the set of operations, and the processing circuitry 310 may be configured to retrieve the set of operations from the storage medium 330 to cause the wireless device 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The wireless device 300 may further comprise a communications interface 320 for communications at least with network node 200 and wireless device 400a, 400b. As such the communications interface 320 may comprise one or more transmitters and receivers, comprising analogue and digital components and a suitable number of antennas for wireless communications and ports for wireline communications.

The processing circuitry 310 controls the general operation of the wireless device 300 e.g. by sending data and control signals to the communications interface 320 and the storage medium 330, by receiving data and reports from the communications interface 320, and by retrieving data and instructions from the storage medium 330. Other components, as well as the related functionality, of the wireless device 300 are omitted in order not to obscure the concepts presented herein.

FIG. 12 schematically illustrates, in terms of a number of functional modules, the components of a wireless device 300 according to an embodiment. The wireless device 300 of FIG. 12 comprises a number of functional modules; a receive module 310e configured to perform step S210, a receive module 310f configured to perform step S212, and a transmit module 310h configured to perform step S216. The wireless device 300 of FIG. 12 may further comprises a number of optional functional modules, such as any of an obtain module 310a configured to perform step S202, a transmit module 310b configured to perform step S204, a receive module 310c configured to perform step S206, a receive module 310d configured to perform step S208, and a decode module 310g configured to perform step S214.

In general terms, each functional module 310a-310h may be implemented in hardware or in software. Preferably, one or more or all functional modules 310a-310h may be implemented by the processing circuitry 310, possibly in cooperation with functional units 320 and/or 330. The processing circuitry 310 may thus be arranged to from the storage medium 330 fetch instructions as provided by a functional module 310a-310h and to execute these instructions, thereby performing any steps of the wireless device 300 as disclosed herein.

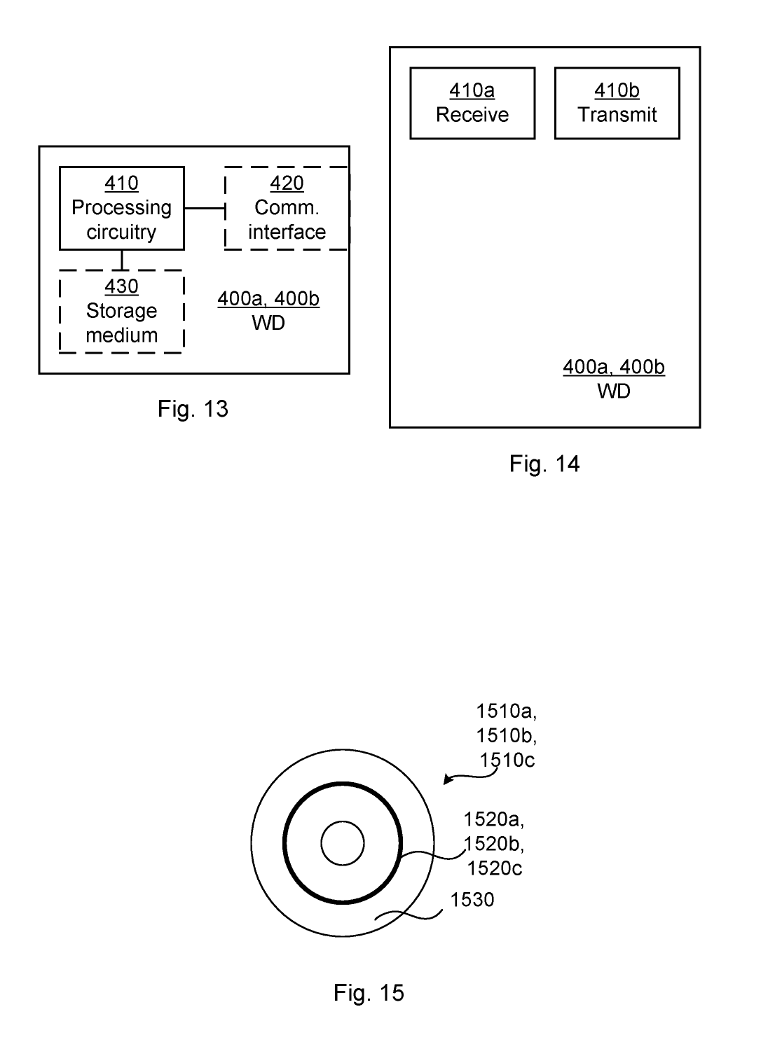

FIG. 13 schematically illustrates, in terms of a number of functional units, the to components of a wireless device 400a, 400b according to an embodiment. Processing circuitry 410 is provided using any combination of one or more of a suitable central processing unit (CPU), multiprocessor, microcontroller, digital signal processor (DSP), etc., capable of executing software instructions stored in a computer program product 1510c (as in FIG. 15), e.g. in the form of a storage medium 430. The processing circuitry 410 may further be provided as at least one application specific integrated circuit (ASIC), or field programmable gate array (FPGA).

Particularly, the processing circuitry 410 is configured to cause the wireless device 400a, 400b to perform a set of operations, or steps, S302-S304, as disclosed above. For example, the storage medium 430 may store the set of operations, and the processing circuitry 410 may be configured to retrieve the set of operations from the storage medium 430 to cause the wireless device 400a, 400b to perform the set of operations. The set of operations may be provided as a set of executable instructions. Thus the processing circuitry 410 is thereby arranged to execute methods as herein disclosed.

The storage medium 330 may also comprise persistent storage, which, for example, can be any single one or combination of magnetic memory, optical memory, solid state memory or even remotely mounted memory.

The wireless device 400a, 400b may further comprise a communications interface 420 for communications at least with network node 200 and wireless device 300. As such the communications interface 420 may comprise one or more transmitters and receivers, comprising analogue and digital components and a suitable number of antennas for wireless communications and ports for wireline communications.

The processing circuitry 410 controls the general operation of the wireless device 400a, 400b e.g. by sending data and control signals to the communications interface 420 and the storage medium 430, by receiving data and reports from the communications interface 420, and by retrieving data and instructions from the storage medium 430. Other components, as well as the related functionality, of the wireless device 400a, 400b are omitted in order not to obscure the concepts presented herein.

FIG. 14 schematically illustrates, in terms of a number of functional modules, the components of a wireless device 400a, 400b according to an embodiment. The wireless device 400a, 400b of FIG. 14 comprises a number of functional modules; a receive module 410a configured to perform step S302, and a transmit module 410b configured to perform step S304. The wireless device 400a, 400b of FIG. 14 may further comprise optional functional modules. In general terms, each functional module 410a-410b may be implemented in hardware or in software. Preferably, one or more or all functional modules 410a-410b may be implemented by the processing circuitry 410, possibly in cooperation with functional units 420 and/or 430. The processing circuitry 410 may thus be arranged to from the storage medium 430 fetch instructions as provided by a functional module 410a-410b and to execute these instructions, thereby performing any steps of the wireless device 400a, 400b as disclosed herein.

FIG. 15 shows one example of a computer program product 1510a, 1510b, 1510c comprising computer readable means 1530. On this computer readable means 1530, a computer program 1520a can be stored, which computer program 1520a can cause the processing circuitry 210 and thereto operatively coupled entities and devices, such as the communications interface 220 and the storage medium 230, to execute methods according to embodiments described herein. The computer program 1520a and/or computer program product 1510a may thus provide means for performing any steps of the network node 200 as herein disclosed. On this computer readable means 1530, a computer program 1520b can be stored, which computer program 1520b can cause the processing circuitry 310 and thereto operatively coupled entities and devices, such as the communications interface 320 and the storage medium 330, to execute methods according to embodiments described herein. The computer program 1520b and/or computer program product 1510b may thus provide means for performing any steps of the wireless device 300 as herein disclosed. On this computer readable means 1530, a computer program 1520c can be stored, which computer program 1520c can cause the processing circuitry 410 and thereto operatively coupled entities and devices, such as the communications interface 420 and the storage medium 430, to execute methods according to embodiments described herein. The computer program 1520c and/or computer program product 1510c may thus provide means for performing any steps of the wireless device 400a, 400b as herein disclosed.

In the example of FIG. 15, the computer program product 1510a, 1510b, 1510c is illustrated as an optical disc, such as a CD (compact disc) or a DVD (digital versatile disc) or a Blu-Ray disc. The computer program product 1510a, 1510b, 1510c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1520a, 1520b, 1520c is here schematically shown as a track on the depicted optical disk, the computer program 1520a, 1520b, 1520c can be stored in any way which is suitable for the computer program product 1510a, 1510b, 1510c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-31. (canceled)

32. A method for data relaying in a wireless communications network, the method being performed by a network node, the method comprising:
transmitting a trigger message for a second wireless device to transmit uplink data in a timeslot; and
transmitting downlink data to a first wireless device in the timeslot.

33. The method according to claim 32, further comprising:
transmitting a notification to the first wireless device to forward the uplink data from the second wireless device in the timeslot to the network node.

34. The method according to claim 32, further comprising:
obtaining an indication that the first wireless device is configured to act as a relay for the second wireless device.

35. The method according to claim 34, wherein the indication is based on positioning data of the first wireless device or a signal to noise ratio of the first wireless device.

36. A method for data relaying in a wireless communications network, the method being performed by a first wireless device, the method comprising:
receiving downlink data from a network node in a timeslot;
receiving uplink data from a second wireless device in the timeslot; and
transmitting the received uplink data to the network node as part of an uplink transmission.

37. The method according to claim 36, further comprising:
receiving a notification from the network node to receive the uplink data from the second wireless device in the timeslot.

38. The method according to claim 36, further comprising:
receiving a notification from the network node before receiving the downlink data from the network node, the notification comprising instructions for the first wireless device to forward uplink data received from the second wireless device in the timeslot to the network node.

39. The method according to claim 36, wherein the uplink transmission comprises an acknowledgement (ACK) protocol message of the downlink data to the network node.

40. The method according to claim 36, wherein the uplink transmission comprises uplink data of the first wireless device to the network node.

41. The method according to claim 36, further comprising:
decoding the received uplink data before forwarding the received uplink data.

42. The method according to claim 36, further comprising:
obtaining an identification of the second wireless device from the second wireless device; and
transmitting a notification of the identification to the network node prior to receiving the downlink data.

43. The method according to claim 42, wherein the indication is based on positioning data of the second wireless device or traffic data.

44. The method according to claim 36, wherein the downlink data from the network node is transmitted using Orthogonal Frequency Division Multiplexing (OFDMA) or Multi-User Multiple-Input and Multiple-Output (MU-MIMO).

45. A method for data relaying in a wireless communications network, the method being performed by a second wireless device, the method comprising:
receiving, from a network node, a trigger for transmitting uplink data in a timeslot; and
transmitting the uplink data in the timeslot to a first wireless device.

46. The method according to claim 45, wherein the second wireless device has lower transmit power usage than the first wireless device.

47. The method according to claim 45, wherein the uplink data from the second wireless device is transmitted using Orthogonal Frequency Division Multiplexing (OFDMA) or Multi-User Multiple-Input and Multiple-Output (MU-MIMO).

48. The method according to claim 45, wherein the wireless communications network is an IEEE 802.11ax wireless local area network.

49. A network node configured for data relaying in a wireless communications network, the network node comprising:
processing circuitry; and
a memory storing instructions that, when executed by the processing circuitry, cause the network node to:
transmit a trigger message for a second wireless device to transmit uplink data in a timeslot; and
transmit downlink data to a first wireless device in the timeslot.

50. A wireless device configured for data relaying in a wireless communications network, the wireless device comprising:
processing circuitry; and
a memory storing instructions that, when executed by the processing circuitry, cause the wireless device to:
receive downlink data from a network node in a timeslot;
receive uplink data from another wireless device in the timeslot; and
transmit the received uplink data to the network node as part of an uplink transmission.

51. A wireless device configured for data relaying in a wireless communications network, the wireless device comprising:
processing circuitry; and
a memory storing instructions that, when executed by the processing circuitry, cause the wireless device to:
receive, from a network node, a trigger for transmitting uplink data in a timeslot; and
transmit the uplink data in the timeslot to another wireless device.
